(19) United States
(12) Patent Application Publication
(10) Pub. No.: US 2005/0078112 A1
(43) Pub. Date: Apr. 14, 2005

(54) Logic analysis device with transmission speed display indicators

(76) Inventor: Yao-Tien Hu, Taipei Hsien (TW)

Correspondence Address: BIRCH STEWART KOLASCH & BIRCH, PO BOX 747, FALLS CHURCH, VA, 22040-0747, US

(21) Appl. No.: 10/680,195

(22) Filed: Oct. 8, 2003

(51) Int. Cl. G06T 11/20

(52) U.S. Cl. 345/440

(57) ABSTRACT

A logic analysis device with transmission speed display indicators is disclosed. The logic analysis device with transmission speed display indicators is disposed between the computer and the peripheral devices to enable the user to identify the operation status visually, such as, data transmission or volume of traffic during the operation of each peripheral device, at the same time to aid the user for determining whether to activate additional peripheral devices to substantially avoid breakdown and improve the accuracy of data signal transmission.

### BACKGROUND OF THE INVENTION

1. The Field of the Invention

The present invention generally relates to a logic analysis device with transmission speed display indicators, and more particularly a logic analysis device with transmission speed display indicators suitable for applying in universal serial bus connectors used for connecting to peripheral devices, wherein the a logic analysis device with transmission speed display comprises a built-in logic analysis circuit for retrieving data signal and identifying the transmission speed of the peripheral devices, and the result is being displayed by a display device.

2. Description of the Related Art

As the computer technology is rapidly developing nowadays, the latest computer has powerful calculation functionality, prompt processing ability and more compact. Accordingly, less number of communication connecting ports of the computer for connecting to the peripheral device can be possible, in that, use of an external hub has been developed for connecting to a variety of peripheral devices. The interface of the available hub is a universal serial bus (USB) connector, which has a capability of connecting with 127 peripheral devices. The USB has three transmission speeds, namely, low speed (1.5 Mb), full speed (12 Mb) and high speed (480 Mb). However, all of the peripheral devices connected to such connector must share the same bandwidth. When the computer user uses multiplexer to process or execute an appliance program, the currently available conventional hub do not have any means for indicating whether or not the loop is available. In other words, the traffic and transmission status for the data transmission of each communication port cannot be displayed and therefore the transmission traffic is unknown and if the user continues to connect more number of peripheral devices or operate the peripheral devices in spite the limitation, the computer system may breakdown or experience unwanted interruption or even adversely affect the accuracy of data input. In order to resolve the above defects, a prior art, discloses a hub with a data traffic display light, as shown in FIGS. 1 and 2. The hub A is located between the computer B and a plurality of peripheral devices C and is linked to the computer B by using a connecting wires D. The internal circuit of the hub A comprises a buffer control module A3 for retrieving the incoming data signal A2 received by the communication connecting port A1, and the buffer control module A3 is capable of sending the traffic status of the data signal A2 to the light emitting element A41 of the light emitting module A4 for displaying a flashing light. The above buffer control module A3 comprises a reset circuit A5, which takes command from the computer B to cancel the data signal A2 stored temporarily in the buffer control module A3 to enable the system to restore to the initial status. Accordingly, the user may mistaken the traffic and transmission status by identifying the flashing light of the light emitting element A41, causing breakdown of the computer system and unwanted interruption during inputting through these peripheral devices, or even adversely affect the accuracy of data input.

### SUMMARY OF THE INVENTION

Accordingly, in the view of the foregoing, the present inventor makes a detailed study of related art to evaluate and consider, and uses years of accumulated experience in this field, and through several experiments, to create a new logic analysis device with transmission speed display for applying in USB in order to increase the efficiency of the peripheral devices. The present invention provides a novel and cost effective logic analysis device with transmission speed display.

According to an aspect of the present invention, the logic analysis device with transmission speed display indicators is disposed between the computer and the peripheral devices to enable the user to identify the operation status visually, such as, data transmission or volume of traffic during the operation of each peripheral device, at the same time to aid the user for determining whether to activate additional peripheral devices to substantially avoid breakdown and improve the accuracy of data signal transmission.

### BRIEF DESCRIPTION OF THE DRAWING

For a more complete understanding of the present invention, reference will now be made to the following detailed description of preferred embodiments taken in conjunction with the accompanying drawings, in which:

FIG. 1 is a view showing an application of a conventional hub in a personal computer;

FIG. 2 is a view showing the block diagram of the conventional hub;

FIG. 3 is a table showing the voltage specification of USB;

FIG. 4 is a true table for the logic analysis method according to a preferred embodiment of the present invention;

FIG. 5 is a view of a flow chart of the operation of the logic analysis device with transmission speed display indicators of the present invention;

FIG. 6 is view showing the logic analysis circuit diagram of the logic analysis device with transmission speed display indicators of the present invention;

FIG. 7 is a view showing the flow chart showing the application of the logic analysis device with transmission speed display indicators of the present invention in a hub;

FIG. 8 is an elevational view showing the application of the logic analysis device with transmission speed display indicators in a personal computer according to one preferred embodiment of the present invention; and

FIG. 9 is an elevational view showing the application of the logic analysis device with transmission speed display indicators in a personal computer according to another preferred embodiment of the present invention.

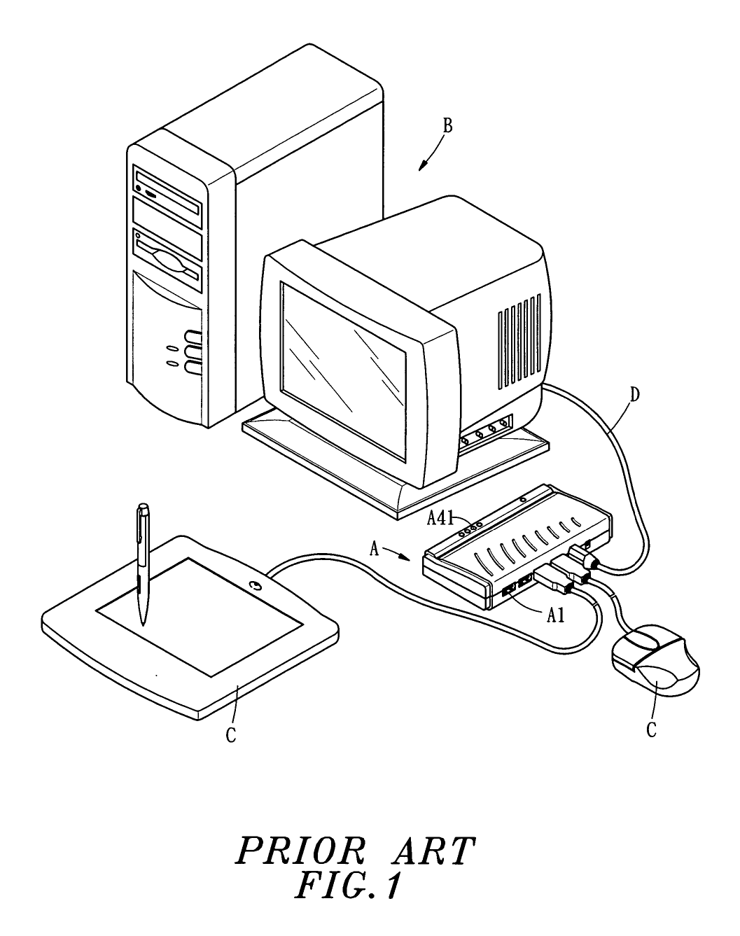

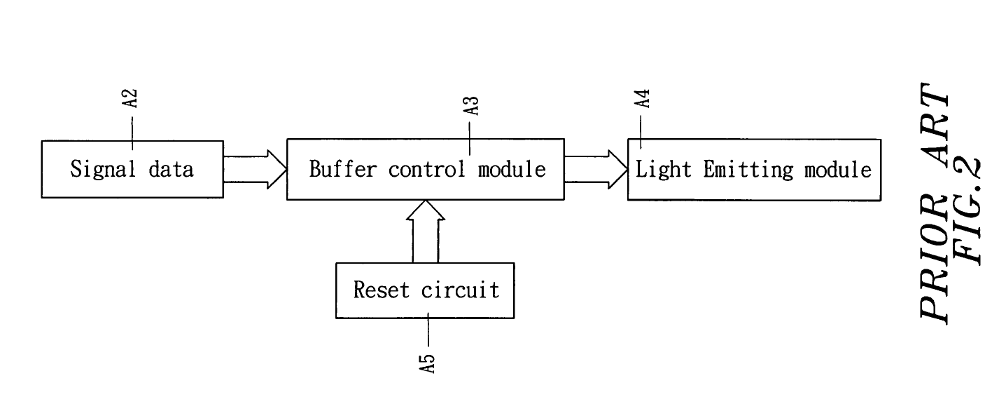

### DETAILED DESCRIPTION OF PREFERRED EMBODIMENTS

Reference will be made in detail to the preferred embodiments of the invention, examples of which are illustrated in the accompanying drawings. Wherever possible, the same reference numbers are used in the drawings and the description to refer to the same or like parts.

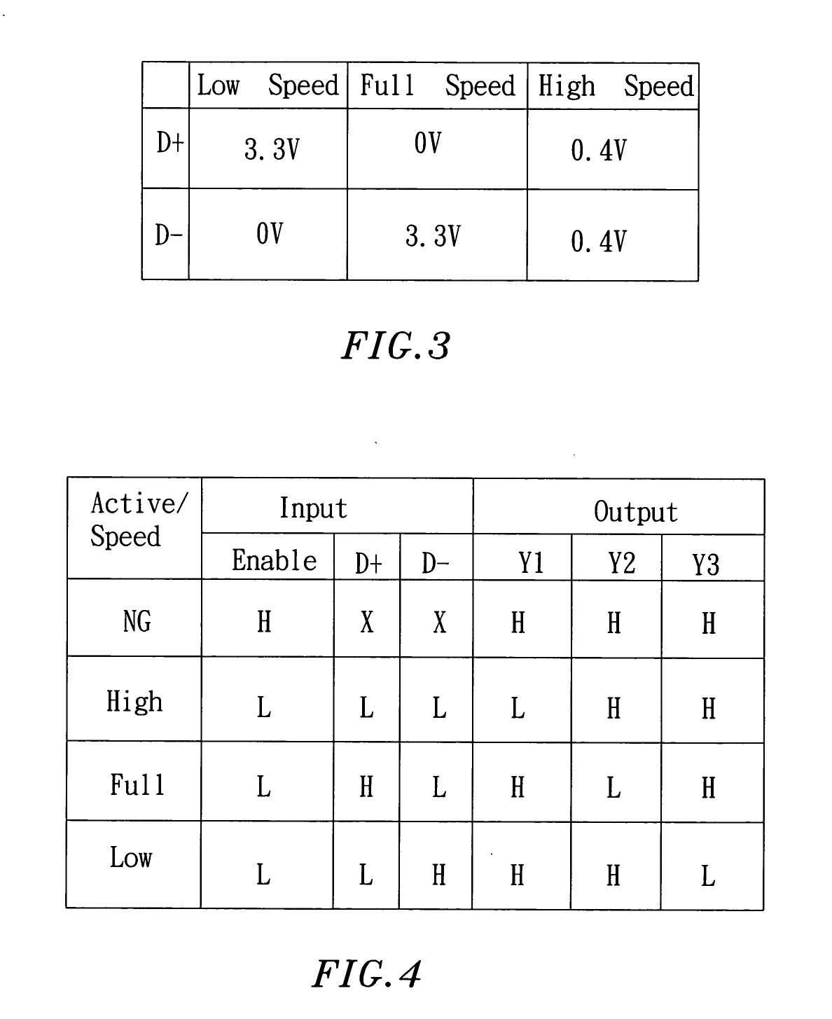

Referring to FIG. 3, the voltage specification of USB indicating the USB has two data transmission wires D+, D− having different transmission speed and voltage level is shown.

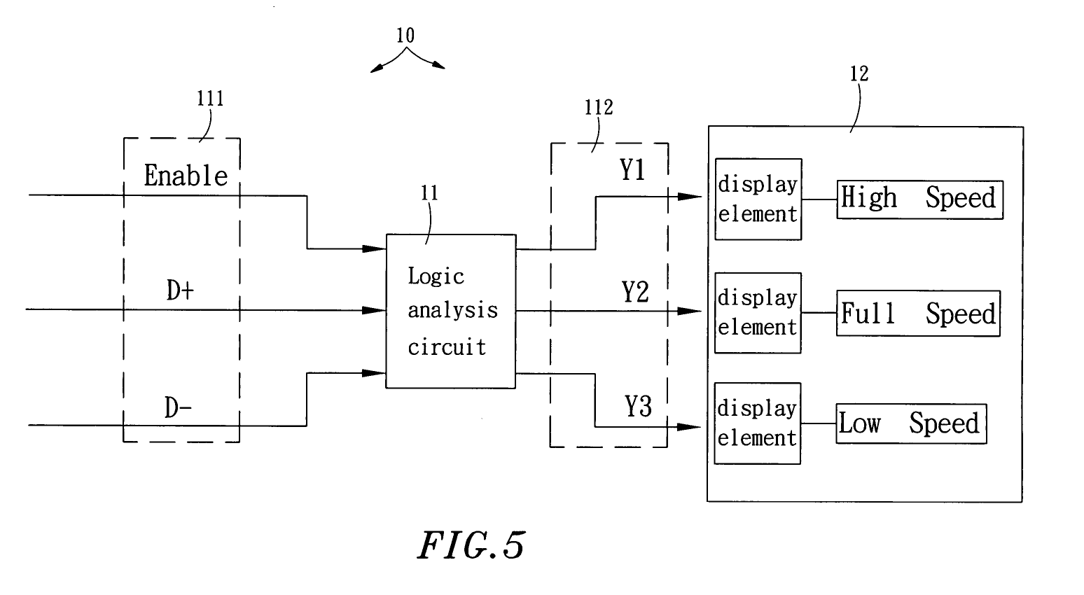

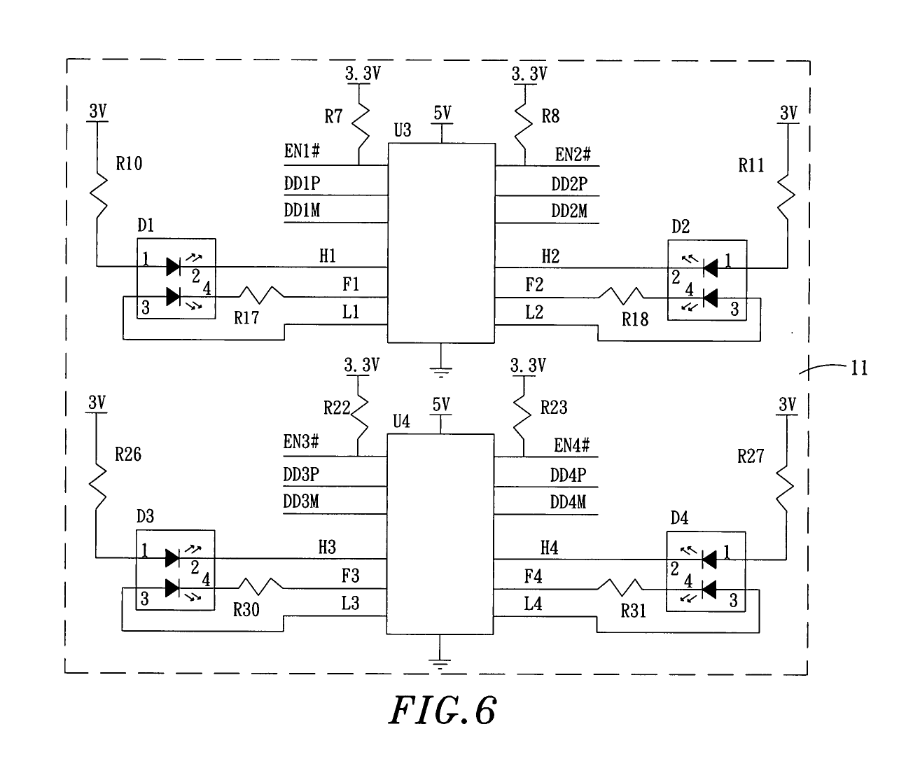

Referring to FIG. 4, 5 and 6, the true table of the logic analysis method, the flow chart of the operation, and the logic analysis circuit diagram of the logic analysis device with transmission speed display indicators of the present invention respectively are shown. The logic analysis device 10 comprises a logic analysis circuit 11 and display device 12. The logic analysis circuit 11 comprises a data signal input 111 and data analyzed output 112. The data signal input 111 can be connected to a download bus 21 of the USB and retrieves the data to the logic analysis circuit 11 for analyzing the transmission speed and to transmit the analyzed data to the data analyzed output 112, which is further transmitted to the display device 12. The display device 12, accordingly, visually displays the corresponding speed according to the transmission speeds. The principle theory of the logic analysis circuit 11 to identify the transmission speed is depicted with reference to FIG. 5 as follows:
Column 1 Active/Speed: indicate transmission speed
NG: indicate error for the USB
High: indicate USB operating in high speed
Full: indicate USB operating in full speed
Low: indicate USB operating in low speed
Column 2 input: indicate data signal input
Enable: indicate signal sent out by the USB controller
D+: indicate transmission wire of USB
D+: indicate transmission wire of USB
X: indicate any logic level status
H: indicate high logic voltage level
L: indicate low logic voltage level
Column 3 output: indicate analyzing data output
Y1, Y2 and Y3: indicate three output pins
H: indicate high logic voltage level
L: indicate low logic voltage level

The above depiction indicates four status for data analyzed output, namely, (1) when the USB is operating abnormally, while Y1, Y2 and Y3 stay in high logic voltage level, (2) when the USB is operating in high speed, while Y1 stay in low logic voltage level, (3) when the USB is operating in full speed, while Y2 stay in low logic voltage level and (4) when the USB is operating in low speed, while Y3 stay in low logic voltage level.

With reference to various statuses for Yl, Y2 and Y3, the display device 12 can be further controlled for displaying the corresponding speeds indicators.

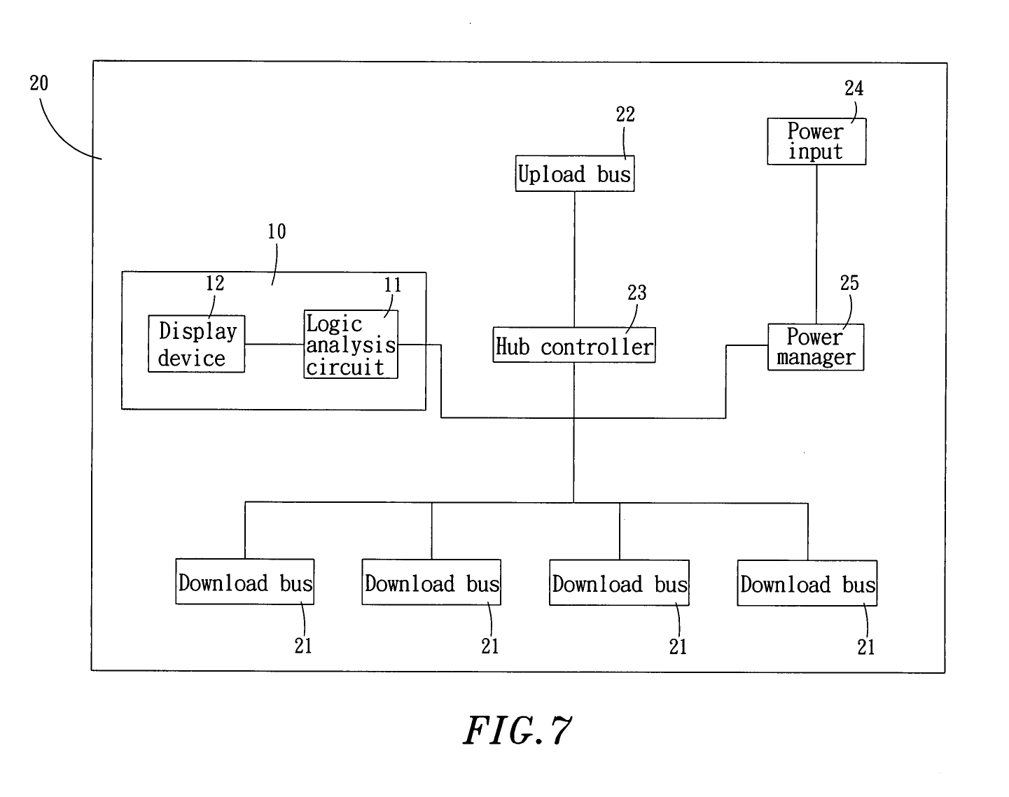

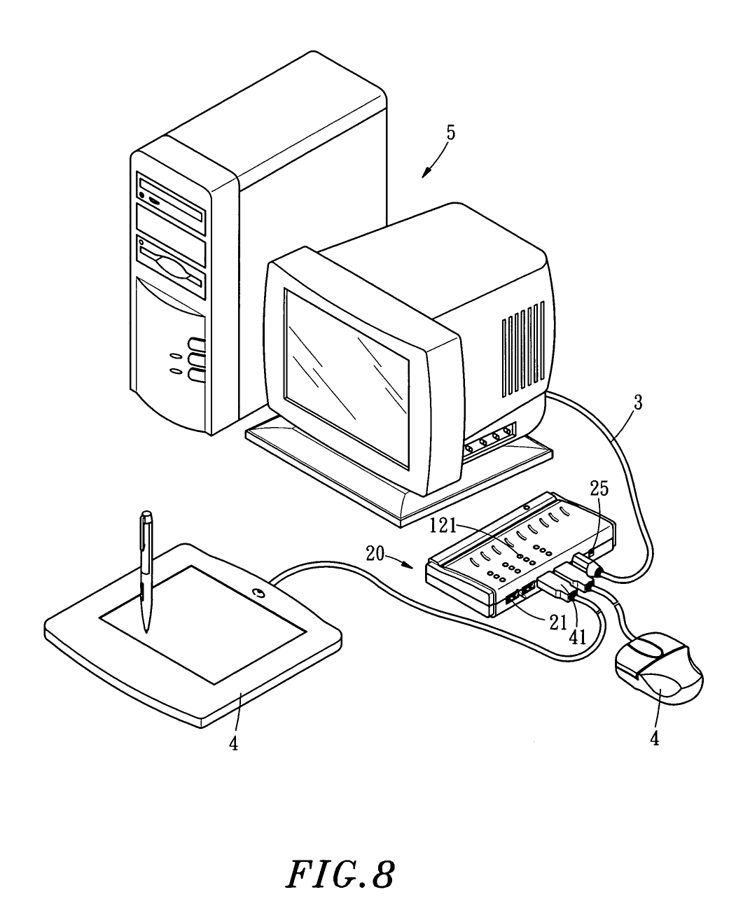

Referring to FIG. 7 and 8, a view of the flow chart showing the application of the logic analysis device with transmission speed display indicators of the present invention in a hub and an application thereof in a personal computer according to one preferred embodiment of the present invention, are respectively shown. The hub 20 comprises a download bus 21 and an upload bus 22 positioned and jointed to the hub controller 23. The logic analysis device 10 is connected between the download bus 21 and the hub controller 23, thus the logic analysis device 10 can retrieve the data transmitted through the download bus 21. The power input 24 transports power to the power manager 25 and is connected to the logic analysis device 10 for supplying power. When the connector 41 of the peripheral device 4 is plugged into the download bus 21, and the connecting wire 3 is used to link the logic analysis device 10 with the computer 5 to the upload bus 22, the hub controller 23 is linked to both sides and send out an Enable signal to indicate that the peripheral device is workable. Meanwhile, the logic analysis device 10 retrieves data transmitted through the download bus 21 and transmits the retrieved data to the logic analysis circuit 11 for analyzing. Next, the analyzed data is transmitted to the display device 12 and the speed corresponding to the data is displayed by the display element 121 of the display device 12. It is to be noted that the display element 121 does not display any indications if the resulting data indicates that the peripheral device is unworkable.

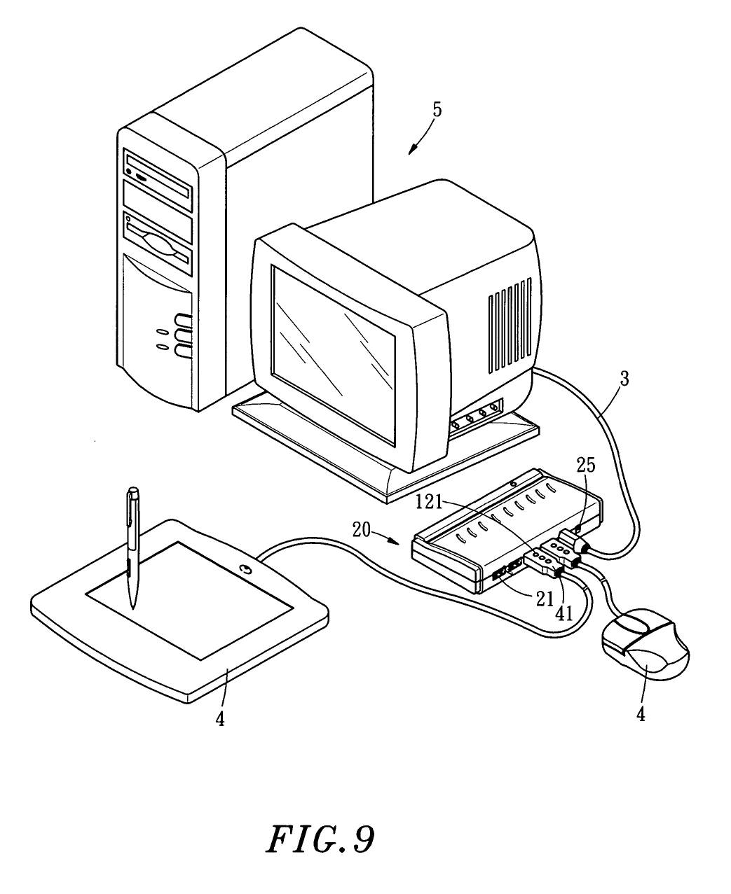

Referring to FIG. 9, the application of the logic analysis device with transmission speed display indicators in a personal computer according to another preferred embodiment of the present invention. The logic analysis device 10 may be positioned within the connector 41 to achieve the features of present invention as described above.

Therefore, compared to the conventional hub, the logic analysis device with transmission speed display indicators of the present invention at least has the following advantages.

The logic analysis circuit 11 of the logic analysis device 10 with transmission speed display indicators takes the download bus 21 of the peripheral device 4 as the guild line for the transmission speed analysis to enable the logic analysis circuit 11 of the logic analysis device 10 of the present invention to identify the transmission speed for every peripheral devices 4.

The display element 121 of the display device 12 displays the speeds corresponding to the various transmission speeds, and the display device 12 is capable of indicating the transmission according to the linked peripheral devices 4.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

1. A logic analysis device with transmission speed display indicators, suitable for applying in the universal serial bus (USB), the logic analysis device with transmission speed display indicators comprising:
a display device, having a display element for displaying a transmission speed;
at least a logic analysis circuit, comprising a data signal input and data analyzed output, said data analyzed output being connected to said display device;
said data signal input is being connected to a download bus of said USB, wherein a data corresponding to a transmission speed of a peripheral device connected to said USB is retrieved by said download bus of said USB for analysis and the transmission speed thereof is identified, and the identified data is transmitted to said display device to visually display said transmission speed of said peripheral device to aid the user to determine whether or not to activate other connected peripheral device so that breakdown can be avoided and an accuracy of data signal transmission can be promoted.

2. The logic analysis device with transmission speed display indicators according to claim 1, wherein said logic analysis device with transmission speed display indicators is set in a USB hub.

3. The logic analysis device with transmission speed display indicators according to claim 1, wherein said logic analysis device with transmission speed display indicators is set in a USB connector.

4. The logic analysis device with transmission speed display indicators according to claim 1, wherein said display element is a LED.

5. The logic analysis device with transmission speed display indicators according to claim 1, wherein said display element is a LCD.

6. The logic analysis device with transmission speed display indicators according to claim 1, wherein said universal serial bus is a USB.
